(19) United States
(12) Patent Application Publication
(10) Pub. No.: US 2007/0061282 A1
(43) Pub. Date: Mar. 15, 2007

(54) Data network information distribution

(75) Inventors: Samrat Ganguly, Monmouth Junction, NJ (US); Sudeept Bhatnagar, Piscataway, NJ (US); Rauf Izmailov, Plainsboro, NJ (US); Yasuhiro Miyao, (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/226,001

(22) Filed: Sep. 14, 2005

(51) Int. Cl. G06F 17/30

(52) U.S. Cl. 707/1

(57) ABSTRACT

Disclosed is a method and apparatus for delivering information of interests from content providers to clients via a data network. A network architecture includes two types of edge servers, referred to as forward proxy servers and reverse proxy servers. The forward proxy servers are assigned to serve particular clients with respect to particular information and the reverse proxy servers are assigned to serve particular forward proxy servers with respect to particular information. Each of the forward proxy servers stores information identifiers associated with information for which the forward proxy server is assigned to serve to at least one client. Each of the reverse proxy servers stores information identifiers and the associated forward proxy servers that the reverse proxy server is assigned to serve with respect to information associated with the information identifiers. Upon receipt of updated content, the reverse proxy servers send the updated content to those forward proxy servers that the reverse proxy server is assigned to serve with respect to the received updated content. The forward proxy servers then provide the updated content to the clients to which they are assigned, either by responding to a request from those clients or by pushing the information to those clients. Network load balancing is provided by a controller network node for controlling the assignments of clients to forward proxy servers and the assignments of forward proxy servers to reverse proxy servers.

### BACKGROUND OF THE INVENTION

The present invention relates generally to data networks, and more particularly to a method and system for achieving load balancing for information distribution.

The traditional Internet web content delivery model consists of a user sending a request to a web server (i.e., website) for particular content stored on the web server. The user request is sent via web browser software (e.g., Microsoft Internet Explorer) operating on a client computer. The content is then delivered from the web server to the client computer, and displayed on the client computer via the web browser. The communication between the client computer and the website may be via the well know hypertext transfer protocol (HTTP). This request/delivery model is well known in the art for data communication via the internet.

Many websites, such as news websites, are constantly updating their content. This presents two problems in the context of the traditional web delivery model described above. First, users do not know when content or information has been updated at the website. Therefore, users do not know when to transmit a request to the website for the updated content. This results in either 1) users sending too many unnecessary requests for information when information has not been updated; or 2) users not sending enough requests and therefore not receiving updated information even though such updated information is available. A second problem with the traditional web delivery model is that users have no way of knowing whether website content is of any interest to them until after the entire content is downloaded. This results in wasted network resources (e.g., bandwidth and server processing) while users download large amounts of content that is of no interest to the user.

These deficiencies are addressed in the emerging web delivery model which is based on meta-data delivery using “real simple syndication” (RSS). In the RSS model, as illustrated in FIG. 1, a user subscribes to an information channel maintained by a publishing website, and the client computer runs software called an aggregator. The publishing website 102 adds new content 106 as it becomes available. For each item of content, the website also stores a short description (i.e., meta-content) 104 along with a link to the new item of content. It is common for the meta-content to be in the form of an eXtensible Markup Language (XML) document. XML is a well known language for describing electronic documents using tags and values associated with the tags. More particularly, XML is actually a metalanguage—a language for describing other languages—which allows for the design of customized markup languages for various different types of documents. XML may be used to store any kind of structured information, and to enclose or encapsulate information in order to pass it between different computing systems which would otherwise be unable to communicate. XML is defined in further detail in Extensible Markup Language (XML) 1.0 (Third Edition), W3C Recommendation 4 Feb. 2004, F. Yergeau, T. Bray, J. Paoli, C. M. Sperberg-McQueen, E. Maler, 2004 W3C, which is incorporated herein by reference. These short descriptions and links to additional content are stored at the publisher and referred to as RSS files.

Based on the subscribed-to channel, the client aggregator 108 periodically sends an update request 110 to the publisher web server 102 and the publisher returns a new version of the RSS file via RSS update 112. This RSS file is sometimes referred to as an RSS feed. The aggregator 108 then displays to the user the short descriptions of the new content items. The user may then review the short descriptions. If the user desires the full content for any of the new items, the user may then request the full content from the web server via a request 114. The publisher responds with the full content 116.

While solving some of the problems of the traditional web content delivery model, the RSS model also presents certain problems. The main problem is that as the RSS model becomes increasingly popular, there are significant server and bandwidth loads at the web server/publisher side. Millions of clients may be interested in a particular RSS information channel. This could result in the millions of clients periodically requesting new versions of the RSS file from the publisher website. There is no scalable way for the publisher website to handle this load of delivering RSS files to millions of clients.

### BRIEF SUMMARY OF THE INVENTION

The present invention provides an improved method and apparatus for delivering information of interests from content providers to clients via a data network. A network architecture in accordance with the principles of the invention provides for two types of edge servers, referred to herein as forward proxy servers and reverse proxy servers. The forward proxy servers are assigned to serve particular clients with respect to particular information and the reverse proxy servers are assigned to serve particular forward proxy servers with respect to particular information. In an advantageous embodiment, the forward proxy servers are located at the client edge of the network, and the reverse proxy servers are located at the content provider edge of the network.

In one embodiment, each of the forward proxy servers stores information identifiers associated with information for which the forward proxy server is assigned to serve to at least one client. Each of the reverse proxy servers stores information identifiers and the associated forward proxy servers that the reverse proxy server is assigned to serve with respect to information associated with the information identifiers.

Upon receipt of updated content, the reverse proxy servers send the updated content to those forward proxy servers that the reverse proxy server is assigned to serve with respect to the received updated content. The forward proxy servers then provide the updated content to the clients to which they are assigned, either by responding to a request from those clients or by pushing the information to those clients.

In an advantageous embodiment, load balancing is provided by a controller network node for controlling the assignments of clients to forward proxy servers and the assignments of forward proxy servers to reverse proxy servers. The controller node stores these assignments in a database in order to implement a load balancing policy of the system.

These and other advantages of the invention will be apparent to those of ordinary skill in the art by reference to the following detailed description and the accompanying drawings.

### BRIEF DESCRIPTION OF THE DRAWINGS

FIG. 1 illustrates the RSS model of network content delivery;

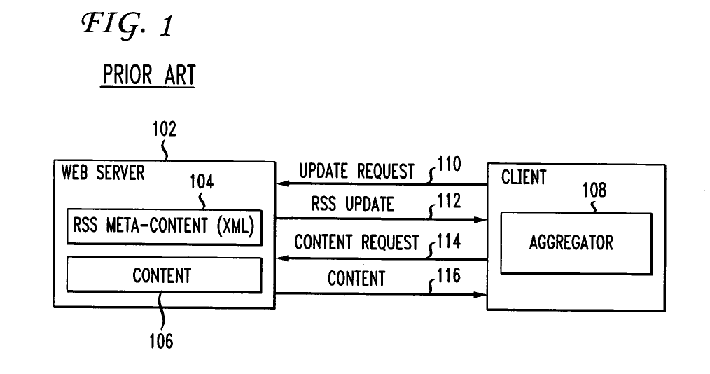

FIG. 2 shows a general network architecture in accordance with an embodiment of the invention;

FIG. 3 illustrates an operational scenario in accordance with an embodiment of the invention; and

FIG. 4 shows a high level block diagram of a computer which may be used to implement a network node in accordance with an embodiment of the invention.

### DETAILED DESCRIPTION

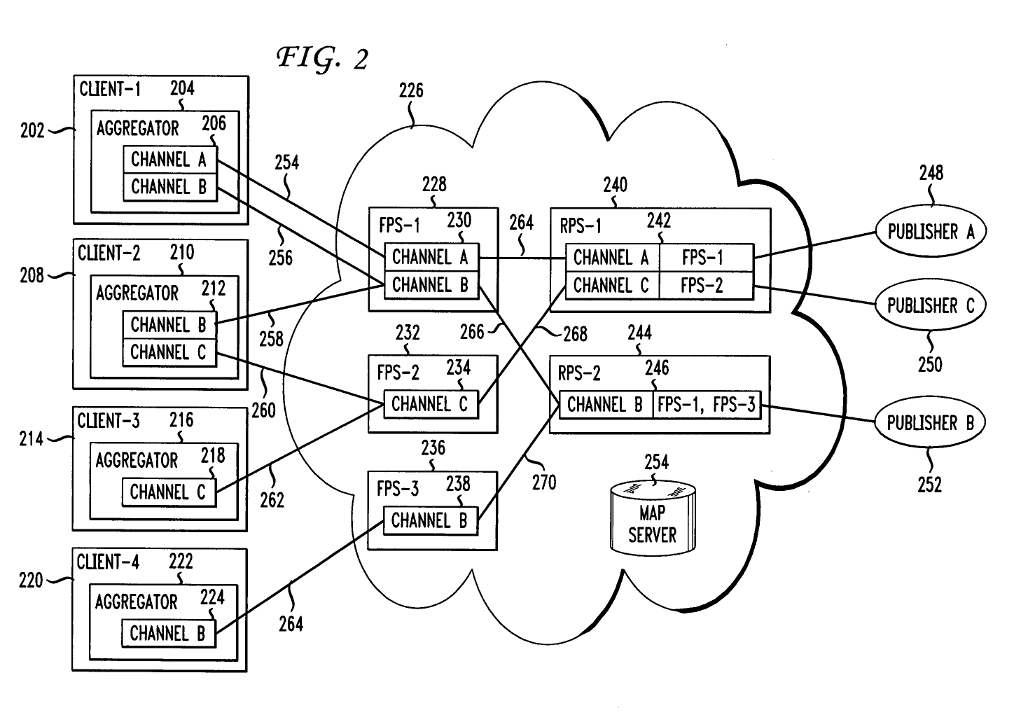

FIG. 2 shows a general network architecture in accordance with an embodiment of the present invention. Four clients (Client-1 202, Client-2 208, Client-3 214, Client-4 220) are shown, each running an aggregator (e.g., an RSS aggregator) application program 204, 210, 216, 222 respectively. The clients may be any type of device capable of executing an aggregator application program and capable of communicating via a network. For example, a client may be a general purpose computer executing an aggregator as an application program, as is well known in the art. This client may connect to the network 226 via any one of the various known connection technologies, such as modem dial-up, cable modem, DSL, Wi-Fi, local area network, etc. A client may also be, for example, a wireless telephone executing an aggregator application and capable of network communication via a wireless network. One skilled in the art will recognize that there are various other devices which are capable of executing an aggregator application program and capable of communicating with a network.

The network 226 may be any type of data network, for example the Internet. Network 226 is shown as a single network cloud for ease of illustration, but it should be understood that network 226 may be one or more interconnected networks as well. One skilled in the art will recognize that the various nodes of the network 226 communicate with each other via well known data networking communication links and techniques. These links are not shown in FIG. 2. The lines connecting the various nodes shown in FIG. 2 represent logical relationships, as will become apparent from the following description.

Also shown in FIG. 2 are three publishers, with publisher 248 publishing information relating to A, publisher 250 publishing information relating to C, and publisher 252 publishing information relating to B. Publishers 248, 250 and 252 could be implemented as network web servers, as is well known in the art. In an advantageous embodiment, publishers 248, 250 and 252 publish content using the RSS model as described above. As discussed above, in the prior art, if clients 202, 208, 214 and 220 were interested in receiving updated content relating to information A, B and C, each of the individual clients would send requests directly to publishers 248, 250 and 252. In a typical network with many clients and many publishers, there is a serious scalability problem, leading to overloaded network resources and network congestion. The present invention solves this problem by utilizing a novel network architecture.

The network architecture in accordance with an embodiment of the invention includes two types of edge proxy servers, called forward proxy servers (FPS) and reverse proxy servers (RPS). In the example shown in FIG. 2, there are three FPSes, FPS-1 228, FPS-2 232 and FPS-3 236. FPSes are located at the network edge closest to the clients, and are used to serve clients with information of interest. Each FPS is responsible for providing updated information to each of a plurality of clients with respect to particular information (e.g., a particular RSS information channel or RSS feed), as that information becomes available from the publishers. At the other edge of the network, closest to the publishers, are the RPSes. Two RPSes are shown, RPS-1 240 and RPS-2 244. RPSes are used to push the data (e.g., RSS data files) from the publishers to the FPSes. The functioning of the FPSes and the RPSes are coordinated by a controller server 254, called a map server, which provides services for IP name resolution, load balancing among multiple FPSes and RPSes, and for handling failures of FPSes and RPSes. The interaction and cooperation between the FPSes and RPSes provides an advantageous network architecture for providing information from the publishers to the clients.

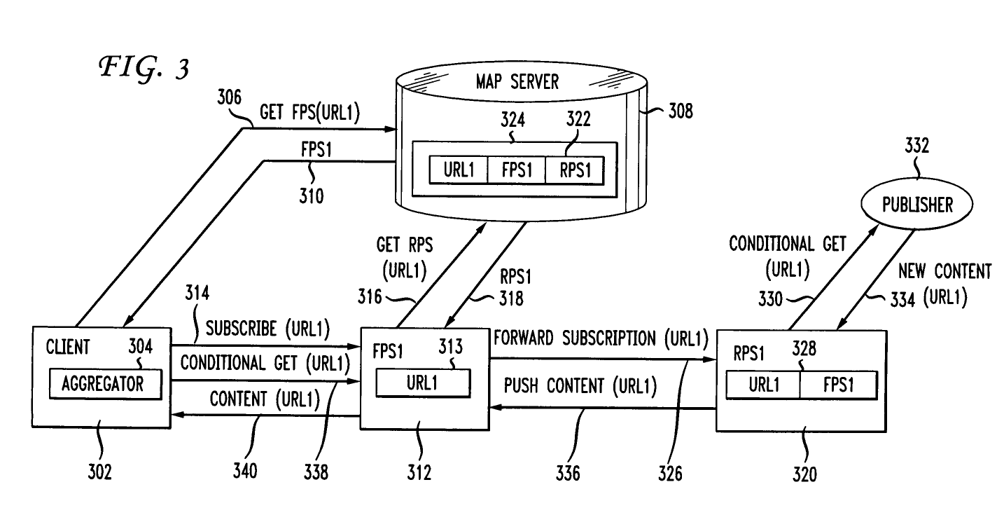

FIG. 2 will now be described in order to describe the interaction between the clients, FPSes, RPSes and publishers. This discussion will assume certain configurations of data tables stored in the various entities without providing a detailed description as to the procedure for configuring these data tables. The detailed description describing the procedure as to how these data tables become configured will be discussed in further detail below in conjunction with FIG. 3.

First, with reference to the clients, each of the client aggregator applications stores a list of information channels which the particular client has subscribed to. For example, Client-1 202 subscribes to channels A and B as shown in subscription table 206. Client-2 208 subscribes to channels B and C as shown in subscription table 212. Client-3 214 subscribes to channel C as shown in subscription table 218. Client-4 220 subscribes to channel B as shown in subscription table 224. The channels subscribed to by a client indicate the information (e.g., RSS files) that a particular client is interested in receiving from various publishers.

In accordance with one aspect of the invention, each of the clients is assigned to one FPS with respect to a particular information channel. For example, in FIG. 2, Client-1 202 is assigned to FPS-1 228 with respect to both information channels A and B, as represented by lines 254 and 256; Client-2 208 is assigned to FPS-1 228 with respect to information channel B as represented by line 258, and is assigned to FPS-2 232 with respect to information channel C as represented by line 260; Client-3 214 is assigned to FPS-2 232 with respect to information C, as represented by line 262; and Client-4 220 is assigned to FPS-3 236 with respect to information channel B as represented by line 264. As shown in FIG. 2, different FPSes can be assigned to different clients with respect to the same information channel. For example, FPS-1 228 serves Client-1 202 with respect to information channel B, and FPS-3 236 serves Client-4 220 with respect to information channel B. This may be appropriate where, for example, Client-1 202 and Client-4 220 are geographically separated by a large distance such that they cannot easily share a single edge server. This is also useful in load balancing in a scenario where a particular channel is of interest to a large number of users.

Each of the FPSes stores a subscription table containing an identification of the information for which at least one client is assigned to that FPS. For example, FPS-1 228 has clients assigned to it with respect to both information channel A and information channel B, and so FPS-1 228 contains a subscription table 230 containing information identifiers identifying information channel A and information channel B. FPS-2 232 has clients assigned to it with respect to information channel C and so FPS-2 232 contains a subscription table 234 containing an information identifier identifying information channel C. FPS-3 236 has a client assigned to it with respect to information channel B and so FPS-3 236 contains a subscription table 238 containing an information identifier identifying information channel B. It is noted that an FPS will only have one entry in its subscription table, even though more than one client is assigned to that FPS with respect to the particular channel. For example, FPS-1 228 has only one entry for information identifier B in subscription table 230, even though both Client-1 202 and Client-2 208 are assigned to FPS-1 with respect to information channel B. It is noted that the term information channel is used herein in order to describe the invention using terminology consistent with the RSS data delivery model. It is to be understood, however, that while one advantageous embodiment is to utilize the principles of the present invention in an RSS embodiment, the principles of the present invention may be applied to any type of data network information delivery system. As such, rather than using the term information channel, the term information identifier may be used to more generally describe an identifier used to identify some type of information of interest to clients. The term information channel will be used herein for consistency with RSS terminology, but it is to be understood that the invention is not limited to RSS embodiments.

Each channel subscription stored in an FPS is assigned to an RPS at the publisher edge of the network, and this assignment is stored in an RPS subscription table. For example, subscription channel A in FPS-1 228 is assigned to RPS-1 240 as represented by line 264. This assignment is further stored in RPS subscription table 242, where RPS-1 240 stores the assignment of information channel A along with the associated FPS-1. Similarly, subscription channel B in FPS-1 228 is assigned to RPS-2 244 as represented by line 266, and this assignment is further stored in RPS subscription table 246, where RPS-2 244 stores the assignment of information channel B along with the associated FPS-1. With respect to the subscription table 246 in RPS-2, it is noted that an identification of FPS-3 236 is also stored in subscription table 246 associated with information channel B, because RPS-2 is also assigned to FPS-3 236 with respect to information channel B, as represented by line 270. Finally, as shown in FIG. 2, subscription channel C in FPS-2 232 is assigned to RPS-1 240 as represented by line 268, and this assignment is further stored in RPS-1 subscription table 242, where RPS-1 240 stores the assignment of information channel C along with the associated FPS-2.

The RPSes periodically retrieve updated information from the publisher websites and push that information to the FPSes. The RPSes retrieve this updated information for those information channels that are stored in their subscription tables. In an advantageous RSS model embodiment, this updated information retrieved from the publishers are RSS files containing meta-data describing additional content available from the publisher. For example, RPS-1 240 has two information channels, A and C, stored in its subscription table 242. RPS-1 242 will periodically send a request for information to publisher 248 to retrieve updated information regarding channel A. Upon receipt of this updated information, RPS-1 240 will push this updated information to FPS-1 228 as indicated in subscription table 242, where FPS-1 is shown associated with information channel A. Similarly, RPS-1 240 will periodically send a request for information to publisher 250 to retrieve updated information regarding channel C. Upon receipt of this updated information, RPS-1 240 will push this updated information to FPS-2 232 as indicated in subscription table 242, where FPS-2 is shown associated with information channel C. RPS-2 244 has one information channel, B, stored in its subscription table 246. RPS-2 244 will periodically send a request for information to publisher 252 to retrieve updated information regarding channel B. Upon receipt of this updated information, RPS-2 244 will push this updated information to both FPS-1 228 an FPS-3 236, as indicated in subscription table 246, where FPS-1 and FPS-3 are shown associated with information channel B.

The information pushed to the FPSes from the RPSes remains stored at the FPSes. Periodically, the clients request updated information from the FPSes assigned to them with respect to particular information channels. For example, aggregator 204 of Client-1 202 will periodically send a request for information to FPS-1 228 for updated information relating to both information channels A and B, because Client-1 202 is assigned to FPS-1 for both of these information channels. Aggregator 210 of Client-2 208 will periodically send a request for information to FPS-1 228 for updated information relating to information channel B, and a request for information to FPS-2 232 for updated information relating to information channel C, because Client-2 208 is assigned to FPS-1 228 with respect to information channel B and to FPS-2 232 with respect to information channel C. In a similar manner, Client-3 214 will request updated information relating to information channel C from FPS-2 232 and Client-4 220 will request updated information relating to information channel B from FPS-3 236.

In the RSS model embodiment, upon receipt of the updated information (i.e., RSS file) at the clients, a user at the client may then determine if he/she wants to retrieve the full content identified by the meta-data in the RSS file.

The network of FIG. 2 also includes a map server 254. The map server 254 acts as an arbitrator between the clients, FPSes and RPSes by coordinating their activities and providing various services. The map server 254 also handles load balancing and fault tolerance as follows. With respect to load balancing, the map server 254 determines the assignment of an FPS to a client with respect to a particular information channel. Thus, when a client first subscribes to a particular information channel, the client requests that the map server assign an FPS to that client. The map server may advantageously assign the least busy FPS in order to achieve load balancing. Similarly, the map server also assigns an RPS to the FPS with respect to the particular information channel. Once again, the map server may advantageously assign the least busy RPS in order to achieve load balancing. The load balancing strategy is flexible, and different policies (e.g., round-robin assignment) may be used, depending upon the particular implementation. Various considerations may be taken into account by the map server 254 in making the above described assignments. The map server stores all assignments in a database.

The map server 254 also handles faults in the system. In accordance with one embodiment, each FPS and RPS may execute a software agent, which periodically sends a keep-alive message to the map server 254. This keep-alive message indicates to the map server that the network node that sent the message is functioning properly. If the map server 254 does not receive a keep-alive message from a particular node within some predetermined time period, then the map server 254 determines that the particular node has failed. In the case of node failure, the map server 254 may intelligently re-allocate client-to-FPS and FPS-to-RPS assignments to ensure continued operation of the content delivery system.

The use of FPSes at the client's edge of the network, and the use of RPSes at the publisher's edge of the network, provides for a scalable network architecture for implementing a content delivery system whereby large numbers of client requests for updated information can be accommodated.

In order to further describe the operation of a network configured in accordance with the present invention, and to further describe the subscription and content delivery process, an operational scenario will now be described in conjunction with FIG. 3. Further, the example scenario of FIG. 3 will be described using the RSS model of content delivery.

FIG. 3 shows Client 302, wanting to subscribe to a particular RSS information channel. Assume that the information channel that Client 302 wants to subscribe to is identified by a uniform resource locator (URL), and more particularly by “URL1”. First, the aggregator 304 of Client 302 sends a getFPS request 306 to map server 308. The getFPS request is a request for the map server 308 to assign an FPS to the client with respect to a particular information channel specified by a URL sent as a parameter of the request. Thus, Client 302 sends getFPS(URL1) as the request 306 to map server 308, indicating that Client 302 wishes to subscribe to the information channel identified by URL1. The map server 308 then determines an appropriate FPS to assign to Client 302 taking into account the various loads on the various available FPSes. Upon a determination of the assigned FPS, the map server 308 transmits the assigned FPS to Client 302 in message 310. In this example, assume that response 310 includes an identification of FPS1 312 as the assigned FPS for this information channel.

The aggregator 304, upon receipt of the assigned FPS, sends a subscribe request 314 requesting a subscription to the information channel identified by URL1. It is noted that the above described steps may be transparent to a user of Client 302, and that the user may merely indicate to aggregator 304 that the user wishes to subscribe to a particular information channel. The aggregator 304 automatically generates and sends the getFPS message, receives the FPS assignment, and generates and sends the subscribe request to the assigned FPS.

FPS1 312 then adds URL1 to its subscription table 313. FPS1 312 then sends a getRPS request 316 to the map server 308 requesting that the map server 308 assign an RPS with respect to the information channel identified in the request. In this case, the getRPS request would be “getRPS(URL1)”. Based on current assignments and the load balancing policy, the map server 308 determines an assigned RPS and transmits an identification of the assigned RPS to FPS1 as message 318. In this example, the map server 308 replies with RPS1 320 as the assigned RPS. The map server 308 also adds a record 322 to its subscription database 324 indicating the assignment of [URL1, FPS1, RPS1].

FPS1 312, upon receipt of message 318, forwards the subscription to RPS1 320 via message 326. Upon receipt of message 326, RPS1 320 adds [URL1,FPS1] to its subscription table 328 indicating that RPS1 320 is assigned to serve FPS1 312 with respect to the information channel identified by URL1. RPS1 320 will periodically perform a conditional get command with respect to the content identified by URL1. A conditional get is part of the well known hypertext transport protocol (HTTP). The request “conditionalGet(URL)” is a request for the recipient to return information identified by the URL only if the content has changed within some time period specified as a parameter in the conditional get command. Thus, RPS1 320 periodically sends the conditional get request conditionalGet(URL1) 330 to publisher web server 332.

When the conditional get request parameters are satisfied (i.e., new content is available), then the publisher web server 332 sends the new content associated with URL1 to RPS1 320 as represented by 334. In the RSS embodiment, the new content would be an updated RSS file containing meta-data describing further content available from publisher 332. Upon receipt of the new content 334, RPS1 320 recognizes that the content is identified by URL1, and performs a look-up in its subscription table 328 to determine to which FPSes it is assigned with respect to URL1. As shown in subscription table 328, RPS1 320 is assigned to FPS1 with respect to URL1. RPS1 320 then pushes the new information content to FPS1 312 via pushContent(URL1) message 336.

At the client side, the aggregator 304 of Client 302 periodically polls FPS1 312 via a conditionalGet(URL1) command 338 to determine if updated content is available. If new content is available, then the aggregator 304 receives the new content from FPS1 312 via message 340. As an alternative, FPS1 312 could push the new content to Client 302 upon receipt from RPS1 320. In such an alternate embodiment, FPS-1 312 would also store an identification of Client 302 in subscription table 313 associated with URL1.

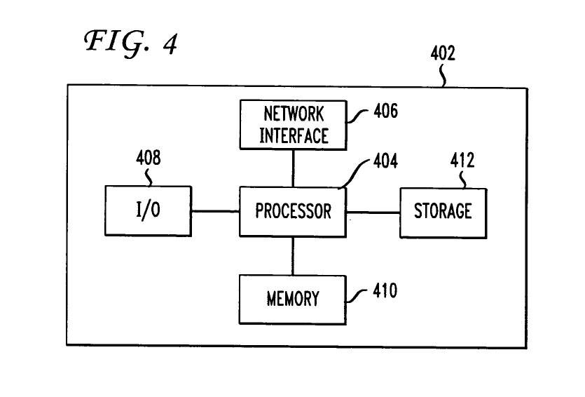

The various elements shown FIGS. 2 and 3 may be implemented using well known networking components. For example, the clients, map server, forward proxy servers, reverse proxy servers and publisher web servers may be implemented using appropriately programmed general purpose computers. Such computers are well known in the art, and may be implemented, for example, using well known computer processors, memory units, storage devices, computer software, and other components. A high level block diagram of such a computer is shown in FIG. 4. Computer 402 contains a processor 404 which controls the overall operation of computer 402 by executing computer program instructions which define such operation. The computer program instructions may be stored in a storage device 412 (e.g., magnetic disk) and loaded into memory 410 when execution of the computer program instructions is desired. Thus, the operation of computer 402 will be defined by computer program instructions stored in memory 410 and/or storage 412 and the operation will be controlled by processor 404 executing the computer program instructions. Computer 402 also includes one or more network interfaces 406 for communicating with other devices via a network. Computer 402 also includes input/output 408 which represents devices which allow for user interaction with the computer 402 (e.g., display, keyboard, mouse, speakers, buttons, etc.). One skilled in the art will recognize that an implementation of an actual computer will contain other components as well, and that FIG. 4 is a high level representation of some of the components of such a computer for illustrative purposes.

Of course, as would be recognized by one skilled in the art, the configuration of hardware and software of an appropriate device will vary depending upon which of the network components is being implemented. In one embodiment, the FPSes communicate with the clients using web services, and communicate with the RPS and map server using TCP/IP sockets. Each FPS runs a server, which listens for subscribe messages from clients and content messages from RPSes. Similarly, the RPSes communicate with the FPSes and map server using TCP/IP sockets. Each RPS also runs a server, which waits for subscribe messages from the FPSes. The map server also communicates with the clients using web services and communicates with the FPSes and RPSes using TCP/IP sockets.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. For example, while the present invention has been described in large part in the context of an RSS data delivery model, the invention is not so limited. The invention is applicable to any type of content delivery in a network.

1. A method for providing information of interest to clients via a network, wherein information is identified by information identifiers, said method comprising the steps of:
storing at each of a plurality of first network servers a plurality of information identifiers;
storing at each of a plurality of second network servers a plurality of information identifiers and associated first network servers;
receiving at said plurality of second network servers information from a plurality of content providers; and
each of said plurality of second network servers transmitting received information to the first network servers associated with the information identifiers associated with said received information.

2. The method of claim 1 wherein said information identifies additional available related content.

3. The method of claim 1 further comprising the step of:
storing network load information in a controller network server.

4. The method of claim 1 further comprising the step of:
receiving from one of said first network servers at a controller network server, a request to assign one of said second network servers to serve said first network server with respect to an information identifier.

5. The method of claim 4 further comprising the step of:
assigning one of said second network servers to serve said first network server with respect to said information identifier.

6. The method of claim 1 further comprising the step of: receiving from a client at a controller network server, a request to assign one of said first network servers to serve said client with respect to an information identifier.

7. The method of claim 6 further comprising the step of:
assigning one of said first network servers to serve said client with respect to said information identifier.

8. A distributed content delivery network for distributing updated information from a plurality of content providers to a plurality of clients comprising:
a plurality of first network servers communicating with said clients, each of said first network servers storing a plurality of information identifiers;
a plurality of second network servers communicating with content providers to receive updated information, each of said second network server storing a plurality of information identifiers and associated first network servers;
each of said second network servers configured to send received updated information to at least one first network server associated with the information identifier associated with said updated information.

9. The distributed content delivery network of claim 8 further comprising:
a controller network server for assigning ones of said first network servers to serve clients with respect to particular information identifiers.

10. The distributed content delivery network of claim 8 further comprising:
a controller network server for assigning ones of said second network servers to serve ones of said first network servers with respect to particular information identifiers.

11. The distributed content delivery network of claim 8 further comprising:
a controller network server for storing network load information.

12. A method for providing information of interest to clients in a data network wherein:
each of said clients is assigned to one of a plurality of first network servers with respect to particular information;
each of said first network servers is assigned to one of a plurality of second network servers with respect to particular information;
said method comprising the steps of:
said second network servers periodically receiving updated information from a plurality of content providers;
said second network servers transmitting received updated information to the first network servers assigned to them with respect to the received updated information; and
said first network servers transmitting said received updated information to the clients assigned to them with respect to the received updated information.

13. The method of claim 12 further comprising the step of:
storing in said second network servers information identifiers and associated first network servers.

14. The method of claim 12 further comprising the step of:
a network controller server assigning said clients to said first network servers with respect to particular information.

15. The method of claim 12 further comprising the step of:
a network controller server assigning said first network servers to said second network servers with respect to particular information.

16. A network for providing information of interest to clients comprising:
a plurality of first network servers, each assigned to serve a plurality of said clients with respect to particular information;
a plurality of second network servers, each assigned to serve ones of said plurality of first network servers with respect to particular information; and
a network controller comprising a memory storing said assignments.

17. The network of claim 16 wherein each of said plurality of first network servers comprises:
a memory storing information identifiers.

18. The network of claim 16 wherein each of said plurality of second network servers comprises:
a memory storing information identifiers.

19. The network of claim 18 wherein the memory of each of said plurality of second network servers further stores identifications of first network servers to which said second network server is assigned with respect to said stored information identifiers.

20. The network of claim 16 wherein said network controller memory further stores network load information.
